(19) United States
(12) Patent Application Publication
(10) Pub. No.: US 2002/0054072 A1
(43) Pub. Date: May 9, 2002

(54) System, method, and device for an interactive messenger

(76) Inventor: Barbara Hayes-Roth, Atherton, CA (US)

Correspondence Address: RENA KAMINSKY, LUMEN INTELLECTUAL PROPERTY SERVICES, SUITE 110, 45 CABOT AVENUE, SANTA CLARA, CA, 95051, US

(21) Appl. No.: 09/738,874

(22) Filed: Dec. 15, 2000

Related U.S. Application Data
(60) Provisional application No. 60/171,208, filed on Dec. 15, 1999.

(51) Int. Cl. G09G 5/00

(52) U.S. Cl. 345/727; 345/706

(57) ABSTRACT

An interactive messenger method sends a computer-controlled interactive agent to a recipient via a communication channel such as email. A sender of the messenger provides content specific to one or many recipients and typically has a particular objective for sending the messenger, such as to invite the recipient to an event, introduce the sender to a new product, or conduct a survey. When the recipient selects a link in the received email message, an interaction between the messenger and recipient is initiated, for example, through a desktop application that opens on the recipient's computer. In addition to having a standard character persona, the agent delivers to and receives from the recipient specific information tailored to the recipient or the sender. For example, a Naughty Cupid messenger invites the recipient on a date, on behalf of a sender, but can also engage in conversation related to Cupid's personality and history. The interaction is mixed initiative: the messenger completes an agenda but also responds to questions or comments initiated by the recipient. The messenger can be sent through any communication channel such as email, telephone, personal digital assistant (PDA), or wireless device.

### CROSS-REFERENCE TO RELATED APPLICATIONS

This application claims the benefit of U.S. Provisional Application No. 60/171,208, filed Dec. 15, 1999, which is herein incorporated by reference.

### FIELD OF THE INVENTION

This invention relates generally to interactive agents. More particularly, it relates to an interactive agent acting as a messenger that can be sent over a communication channel to a recipient with whom it interacts in a specifiable manner.

### BACKGROUND ART

Recent developments in software technology support the creation of interactive agents that can interact with people, with one another, and with other computer-controlled systems. Some of these agents can interact in natural language, sometimes including speech input or output. Some agents may be “embodied” in animation and include animated gestures or expressions in their interactions. Some agents may perform their functions on web sites, in stand-alone applications, or in email. They may interact via desk-top or lap-top computers, telephones, hand-held wireless devices, or other communications media. Some agents may have personas, including a biography, personal data, emotional or other psychological qualities, etc. Some agents may perform particular jobs, such as customer service, sales assistance, learner assistance, survey administration, game play partnering, entertainment, etc. They may personalize their interactions to known preferences or profile data of individual users. Agents also may interact with other computational entities, such as databases, e-commerce systems, web browsers, etc. It will be apparent to one familiar with these developments that interactive agents may exhibit a great variety of specific combinations of features and functions, not unlike the great variety of specific features and functions exhibited by human beings. However, current interactive agents reside at Web sites or other destinations. In order to interact with them, users must go to the destinations where they are deployed. Accordingly, applications for interactive agents are limited to those that can operate successfully in the present location-based mode of deployment.

Of course, there are ways to dispatch a customized message to a designated recipient, via proactive communication channels. Several types of messages can be sent on these channels, including standard text, text containing a URL link to a web site, graphics images, and recorded voice messages, sometimes including questions for user response (e.g., “If this is Ms. Jones, please say “yes” or press the #1 on your phone.”).

In addition, recent technical innovations allow more sophisticated, media-rich messages to be sent over these communication channels.

For example, electronic greeting cards, or e-cards, have become popular for sending greetings that were previously sent on paper cards through the mail. To send an e-card, a sender enters a request at a Web site of a provider of e-card services, such as Blue Mountain or Hallmark. The sender selects a type of card, enters the email address of the recipient, and may be able to type a short personalized message, such as “Congratulations, Judy! I always knew you could do it.” At the time requested by the sender, the e-card provider sends an email to the recipient alerting the recipient that he or she has received an e-card. The message contains a link to a Web site containing the specific e-card. The recipient clicks on the link, which opens a browser at the site of the e-card. Typical e-cards have pictures and words related to a particular holiday, event, or sentiment. Some cards play animations or music. While these cards are wonderful to receive, they often hold the attention of the recipient for only a few minutes and have extremely limited functionality. In particular, they do not engage recipients in meaningful exchanges of information. More generally, they do not yet take advantage of the full range of interactive agent technology available. Therefore applications are limited to those that do not require more advanced interactive functionality.

A few companies, such as Radical Mail and ToggleThis, have developed products similar to e-cards, but incorporating more sophisticated streaming video or animation technology. In some cases, recipients can click on certain items in the display in order to influence the animation or the course of the presentation or to signal an interest in a particular product or feature. Again, however, while these media-rich messages are wonderful to receive and even to interact with, they do not allow for sophisticated interactions or rich information exchange with recipients. They do not yet take advantage of the full range of interactive agent technology available. Therefore applications are limited to those that do not require more advanced interactive functionality.

### SUMMARY

Accordingly, the present invention makes use of existing interactive agent technology to enable senders to dispatch interactive messengers to initiate or solicit personalized interactions with designated recipients, via pro-active communications channels, including email, phone, and PDA. The interaction between messenger and recipient can be mixed-initiative, with either of the two participants initiating a conversation by making a comment, asking a question, or making a gesture, and the other participant responding if and how they choose. Moreover, an interactive messenger may have an individual persona and related behavior, other behavior associated with the specific purpose of a particular messenger application, or information or behavior personalized to the recipient.

Specifically, the present invention provides a method for creating an interactive messenger, containing the following steps: creating a computer-controlled agent that can engage a recipient in an interaction via a communication channel; enabling the agent to employ content provided by a sender while engaging the recipient in the interaction; and providing a start mechanism for the interaction to the recipient via the communication channel. Activation of the start mechanism initiates the interaction between the agent and the recipient. The sender and recipient typically have a relationship such as employer-employee, enterprise-customer, teacher-student, friend-friend, professional-client, representative-constituent, or partner-partner. The messenger interaction is preferably designed to achieve a particular objective corresponding to the relationship.

Preferably, the interaction includes delivery of dialogue by the agent or recipient, including initiating dialogue and responding dialogue such as questions and answers. The interaction can also include actions such as gestures, control of a browser or other application, or reading to and writing from a database. The agent preferably contains content such as a persona, mood, visual appearance, audible voice, or chat topic. A mood of the agent or recipient influences and is influenced by actions of the agent or recipient.

The messenger can be sent over any communication channel such as email, telephone, personal digital assistant, or wireless device. The start mechanism that initiates the interaction is either one that requires a permission signal from the recipient, such as a URL that is selectable by the recipient, or an automatic start mechanism that is triggered when the recipient receives the mechanism.

Preferably, the method also includes generating a report that includes information about either sending the start mechanism or, after the interaction has been started, about a component of the interaction. For example, the report can describe actions performed by the messenger or recipient during the interaction, such as the recipient's answering a question, initiating actions, or providing information. The report can also include a statistic summarizing a feature of the interaction. The report is preferably sent to the sender of the messenger or recorded in a database.

The content employed by the agent includes instructions about actions to perform, conditions under which the actions are performed, an address of the recipient or sender, or a database in which a report of the interaction can be written. If the messenger is sent to a single recipient, the messenger content is preferably obtained from values of slots in a form filled out by the sender, and then either manually or automatically incorporated into the messenger. Alternatively, if the messenger is sent to a plurality of recipients, the recipients and associated messenger content are listed in a database. Viral distribution, in which a recipient provides new messenger content, and the start mechanism is sent to a new designated recipient, is also provided.

### BRIEF DESCRIPTION OF THE FIGURES

FIG. 1 is an image displaying a gesture of a Naughty Cupid persona used in a preferred embodiment of the present invention.

FIG. 2 shows a customizable messenger role created for Naughty Cupid.

FIG. 3 shows the Naughty Cupid messenger role of FIG. 2 with customized values specified by a sender named Barbara for use in interaction with a recipient named Rick.

FIG. 4 illustrates a request form filled out by a sender named Barbara to specify the variable values the Naughty Cupid messenger should use when interacting with the recipient named Rick.

FIG. 5 is a transcript of Naughty Cupid's interaction with the recipient named Rick, following specifications for customizing messenger variables provided by the sender named Barbara.

### DETAILED DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

The preferred embodiment of the interactive messenger of the present invention uses interactive agents created and run with a commercially available authoring tool “Imp Character Development Kit (ICDK)” and run-time system “Imp Engine,” developed by Extempo Systems, Inc. using inventions described in U.S. Pat. No. 6,031,549, entitled “System and Method of Directed Improvisation by Computer Characters,” and U.S. Patent Application, “System, Method, and Device for Authoring Content for Interactive Agents,” both of which are herein incorporated by reference. However, it will be apparent to one skilled in the art that the proposed interactive messenger can be created with alternative interactive agent authoring tools and run-time systems.

In the preferred embodiment, development of an interactive messenger starts with the creation of an interactive agent, which includes a persona and a customizable messenger role. In particular, let us take the example of an interactive “Naughty Cupid” messenger.

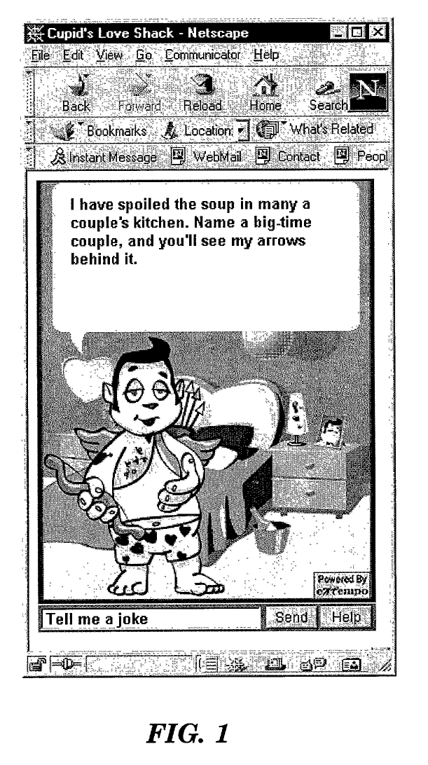

Naughty Cupid was created as an agent possessing a humorously naughty persona related to the mythical character Cupid, including a backstory, appearance, animated gestures and expressions, emotional dynamics, and chat topics related to love and romance. FIG. 1 shows an image displaying one of various gestures of a “Naughty Cupid” persona used in the preferred embodiment. In particular, FIG. 1 illustrates a “talk” gesture of Naughty Cupid. Cupid was also given content enabling him to understand various messages a user might type in to him (“How are you Cupid?”, “Do you really use those arrows?”), dialogue for responding to those messages (“Loverly, my romantic friend.”, “I only use them when love is war.”), additional dialogue for initiating conversations of his own (“Care for a little romantic chat?”), various stories and jokes he can tell the user (“I remember the time I lit the spark for Antony and Cleopatra . . . ”), etc. He also was given moods that make him happy when the user praises him and sulky when the user criticizes him, along with mood-sensitive variations in his dialogue and gestures.

All of the present Naughty Cupid persona content was created using the Extempo ICDK for subsequent operation using the Extempo Imp Engine. However, it will be apparent to one skilled in the art that Naughty Cupid's persona content also could be created with alternative development tools and operated with an alternative run-time engine. Similarly, it will be apparent to one skilled in the art that it is possible to create agents possessing a great variety of alternative personas, representing real (e.g., celebrities such as Martha Stewart), mythical (e.g., Santa Claus), fictional (e.g., Peter Pan), or invented characters (e.g., Molly Bear), and to substantiate them with distinctively appropriate appearances, gestures, dialogue, moods, etc.

Typical holiday characters include Cupid, the Easter Bunny, a Halloween witch, a Thanksgiving Turkey, and Uncle Sam. Fictional characters can be taken from sources such as books, stories, myths, fairy tales, films, television shows, plays, songs advertisements, and operas. And it will be apparent to one skilled in the art that the content implemented for such an agent could be implemented for delivery using various communications channels (e.g., email, phone, PDA) and user interface technologies (e.g., 2D or 3D graphics or animation, text-to-speech, speech understanding, text chat, etc.).

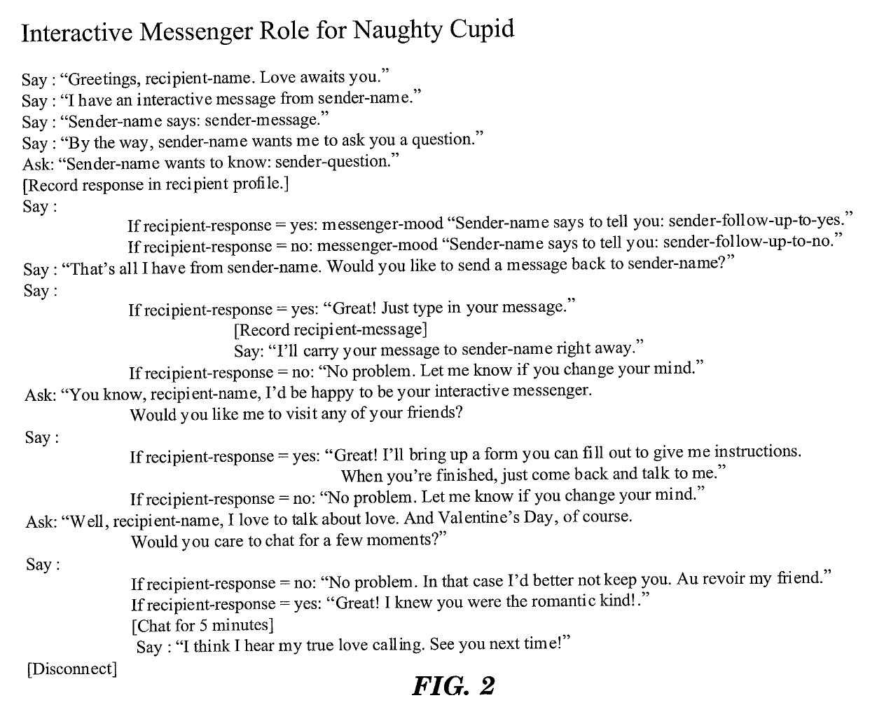

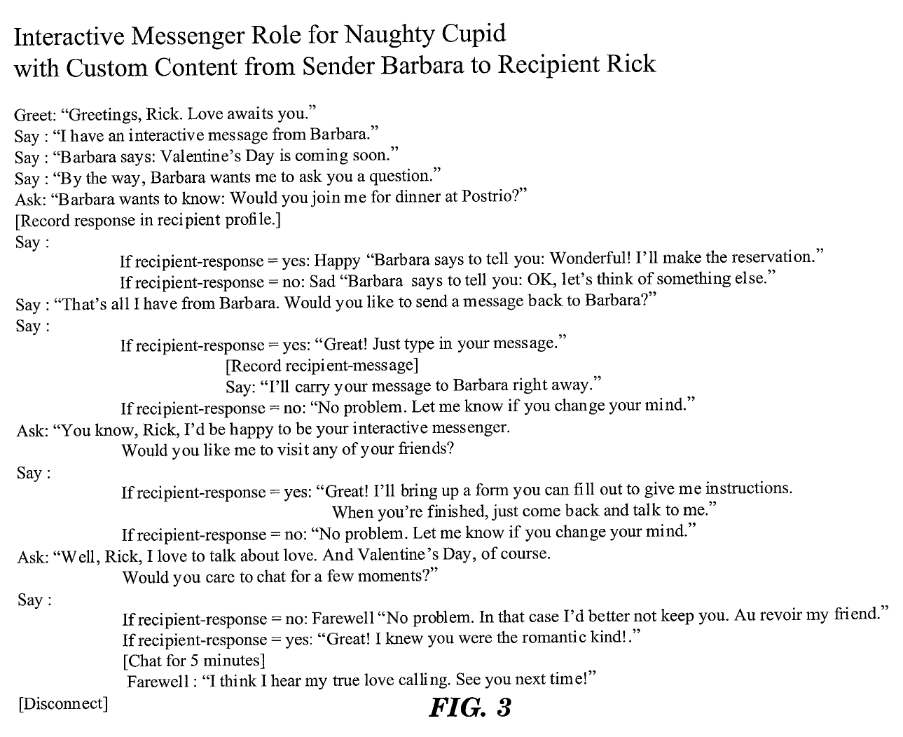

FIG. 2 shows a customizable messenger role created for Naughty Cupid. The role contains a sequence of interactive steps that Naughty Cupid will work through while interacting with a messenger recipient. Notice that several of the steps contain variables, such as sender-name, recipient-name, sender-message, and sender-question. These variables are replaced by customized values specified by a sender, as explained below, for use in interaction with a designated recipient. For example, the variables in the present Naughty Cupid messenger role might be replaced with alternative values, such as: sender-name=“Barbara” vs. “Mom,” recipient-name=“Rick” vs. “Aaron,” sender-question=“Would you like to have dinner at Postrio?” vs. “Did you get something for your girlfriend?”, messenger-mood=happy vs. sad. In this manner, a sender can instruct Naughty Cupid to deliver customized interactive messenger behavior to different recipients or to the same recipients on different messenger missions. For example, FIG. 3 shows the Naughty Cupid messenger role of the present example, with customized values specified by a sender named “Barbara” for use in interaction with a recipient named “Rick.” Similarly, different senders can instruct Naughty Cupid to deliver their own customized interactive messenger behaviors to their own recipients by specifying appropriate values for his interactive messenger role variables.

It will be apparent to one skilled in the art that the present interactive messenger role created for Naughty Cupid is only one of a large class of interactive messenger roles that could be created in the same manner to provide a variety of kinds and patterns of messenger interactions with recipients. A messenger role might include various actions, such as: saying a message (e.g., “I'm Cupid, the love god.”), asking a question (e.g., “Are you ready for Valentine's Day?”), answering a question (e.g., “I only use my arrows when love is war.”), telling a joke or story (e.g., “I remember the time a lit the spark between Antony and Cleopatra . . . ”), operating a web browser of other application, changing a mood (e.g., becoming sulky when insulted by the recipient), displaying a gesture (e.g., slumping body language when feeling sulky), recording information in a database (e.g., record the recipient's response to a question), etc. Similarly a messenger role might include various action sequences and conditional sequences of varying lengths. Finally, a messenger role might include different numbers and types of variables whose values can be customized by different senders for use with different recipients.

A sender specifies how an interactive messenger, such as Naughty Cupid, should customize its interactive messenger behavior for a given recipient by providing replacement values for each of the variables in its interactive messenger role. In the preferred embodiment, this can be achieved in alternative ways.

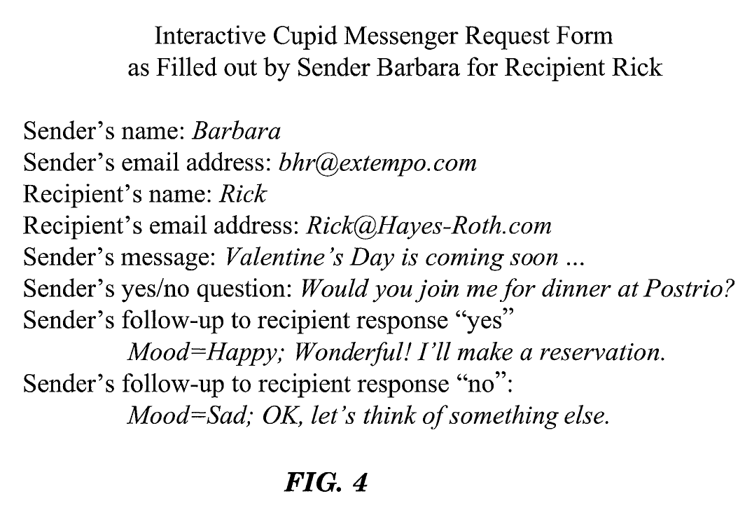

In the preferred embodiment for individually customizing Naughty Cupid for individual recipients, a sender fills in a standard electronic form with pre-defined slots for the variable values needed in the present messenger role to customize Naughty Cupid's messenger interactions with a designated recipient. This information is automatically compiled into a recipient database from which Naughty Cupid automatically retrieves variable values using standard database queries and inserts these variable-values into appropriate parts of its interactive behavior during any interaction with the specified recipient. For example, FIG. 4 shows how, in the present example, the sender named Barbara would fill out a form for the Naughty Cupid Messenger in order to specify the variable values he should use when interacting with the recipient named Rick.

In the preferred embodiment for mass customizing Naughty Cupid for a number of different recipients, a sender creates a recipient database, with necessary variable values specified for each recipient listed in the database. Naughty Cupid uses standard database queries to automatically retrieve and insert appropriate variable-values for a given recipient into its interactive behavior during an interaction with that recipient.

Finally, in the preferred embodiment, a sender may use the ICDK to enter recipient-specific variable values directly into Naughty Cupid's content knowledge base. If the sender wishes to use Naughty Cupid with different recipients, he or she must also insert appropriate preconditions into his knowledge base, making selection of alternative values for each variable dependent upon recipient identity. It will be apparent to one skilled in the art that these and other standard content specification methods may be used by a sender to specify how Naughty Cupid or other interactive messengers should customize their messenger behavior during interactions with different recipients.

In general, the messenger role and associated customized content may be a large or small fraction of an interactive messenger's available interactive behaviors. For example, Naughty Cupid has a modest messenger role with a modest number of customization variables, but in his persona as Cupid, he is fully versed in the art of love, famous lovers in contemporary life, history, and fiction, his own romantic life and marital history, as well as those of the other gods on Mt. Olympus, various stories, poems, and jokes about love and romance, as well as some related “naughty” bits.

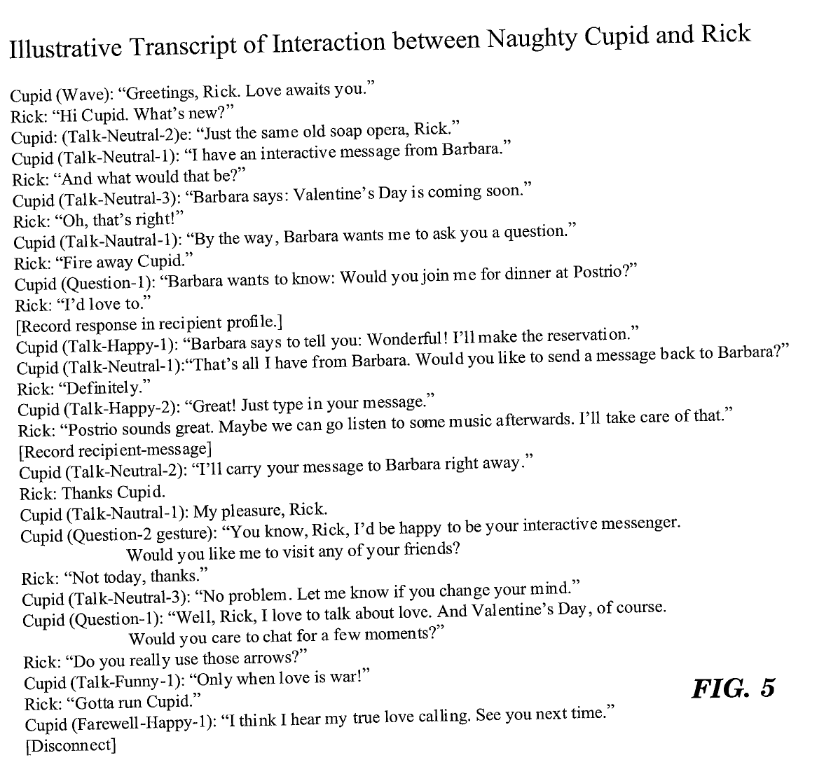

During an interaction with a recipient, Naughty Cupid can respond to the recipient's comments and questions about any part of his knowledge or persona at any time, even in the midst of pursing his interactive messenger role. FIG. 5 shows an illustrative transcript of Naughty Cupid's interaction with the recipient named “Rick,” following specifications for customizing messenger variables provided by the sender named “Barbara.” In this transcript, Naughty Cupid performs his messenger role, replacing variables in his dialogue and behavior with appropriate values as specified by Barbara and in dependence upon Rick's behavior during the interaction and using those values to customize his interactions with Rick. For example, Naughty Cupid selects and displays instances of the types of gestures specified by Barbara (e.g., say, ask, greet, farewell) and in dependence upon his current mood (e.g., neutral, happy, sad). He also interleaves responses to unrelated comments or questions initiated by Rick that occur during execution of his messenger role, for example: “Hi Cupid. What's new?” In some cases, Naughty Cupid uses variable values specified for his interactive messenger role to customize some of his non-messenger behavior. For example, he inserts the recipient's name in non-messenger dialogue, such as his greeting: “Greetings, Rick. Love awaits you.” It will be apparent to one skilled in the art that an interactive messenger such as Naughty Cupid can be created to engage a recipient in various mixed-initiative interactions, customizing and interleaving gestures and dialogue associated with its messenger role and its persona. Moreover, it will be apparent that similar interactive messengers can be created by the same method for different character personas, different messenger roles, and different customized content.

After Naughty Cupid has been given his customized content for a given recipient, standard techniques are used to send an email to that recipient, where the email informs the recipient that Naughty Cupid has an interactive message and supplies a link the recipient can click to activate Naughty Cupid. When Naughty Cupid is activated, he opens up a user interface on the recipient's desk-top and establishes a communications link to the Imp Engine that accesses his content and controls his behavior and runs on a remote server. Naughty Cupid greets the recipient and proceeds to engage the recipient in accordance with his interactive messenger role and also to engage in other interactions initiated by the recipient. The recipient may spend as much time as he or she desires interacting with Naughty Cupid in messenger-related and non-messenger-related interactions. It will be apparent to one skilled in the art that Naughty Cupid interactive messenger, and other interactive messengers, may be dispatched to a designated recipient over a variety of communications channels, including email, phone, and PDA. Moreover, it will be apparent to one skilled in the art that Naughty Cupid, and other interactive messengers, can be invoked automatically upon receipt by recipient or by recipient's selection of a URL, selection of an active element in an interface, voice command, push-tone selection, or a variety of other standard techniques whereby the recipient signals permission to interact. Thus a start mechanism for the interactive messenger can be an opt-in mechanism triggered by a specific permission signal by the recipient or an automatic initiation mechanism triggered by receipt of the mechanism by the recipient.

In the context of the interaction between Naughty Cupid and the recipient, the recipient may be given an opportunity to customize and send Naughty Cupid as an interactive messenger to another recipient of his own. This opportunity may be communicated to the recipient by a button or other interface element that accesses a customization form, for example. This opportunity can be offered to the recipient and facilitated by Naughty Cupid himself. It will be apparent to one skilled in the art that, regardless of how this opportunity is communicated to the recipient, it creates a possibility of “viral” spread of Naughty Cupid and other interactive messengers.

Naughty Cupid sends two types of reports regarding his interactive messenger services back to his sender: when he has been sent to a recipient and when he has been engaged in an interaction with a recipient. In both cases, he reports a variety of information, for example: Date, time, sender, recipient, messenger behavior, recipient behavior. Specifically, he reports on recipient actions such as answering a question posed by the messenger, providing information requested by the messenger, initiating other actions, and offering information to the messenger. The report can also include a statistic summarizing a particular feature of the interaction, including the number of interactions with the recipient, the duration of the interaction, the number of actions by the messenger, the number of actions by the recipient, the number of questions answered correctly by the recipient, and the number of times the messenger fails to understand the recipient's dialogue. Naughty Cupid delivers his reports directly to the sender via email. He also can deliver his reports into a recipient database. It will be apparent to one skilled in the art that these types of reports can be generated for any interactive messenger and delivered to the sender via email, database, or other channel.

It will be apparent to one skilled in the art that the above embodiment merely illustrates one of many possible embodiments of the invention, each of which has many possible interactive messenger applications, for example: personal shopper, learning guide, survey agent, customer care agent, employee benefits agent, social secretary agent, holiday greeting agent, event greeting agent, etc. In general, the messenger interaction is designed to achieve a particular objective. Possible objectives include, but are not limited to, acquiring information from or delivering information to the recipient; inviting the recipient to attend an event or participate in an activity; making an appointment with the recipient; delivering a social, holiday-related, or birthday message to the recipient; managing a customer relationship with the recipient; providing customer service to the recipient; developing awareness of a brand in the recipient; assisting the recipient in making a purchase or obtaining a service; conducting a survey in which the recipient is asked to participate; running a contest in which the recipient is invited to participate; persuading the recipient to perform an action; helping the recipient learn something; and promoting an event, service, enterprise, person, or product. Note that the objective is dependent upon the type of relationship between the sender and recipient. Possible relationships include, but are not limited to, employer-employee, enterprise-customer, teacher-student, friend-friend, professional-client, representative-constituent, and partner-partner.

For example, an interactive messenger role for a personal shopper might follow this pattern: greet the shopper, announce the shopping occasion, ask if the shopper wishes to consider shopping now, if no: make a future date for shopping & farewell, if yes: inform shopper of the recommended shopping sites and product offerings, determine which sites the shopper wishes to visit, escort the shopper to the desired sites, at each site display the recommended products, track the shopper's purchases, farewell.

As a second example, an interactive messenger role for a learning guide might follow this pattern: greet the learner, introduce the lesson, administer a knowledge assessment pre-test, provide appropriate feedback and encouragement, present alternative lectures depending on the outcome of the knowledge assessment, invite and answer questions, summarize the lecture, administer a knowledge assessment post-test, provide appropriate feedback and reinforcement, say goodbye.

More generally, it will be apparent to one skilled in the art that the above embodiment may be altered in many ways without departing from the scope of the invention. Accordingly, the scope of the invention should be determined by the following claims and their legal equivalents.

What is claimed is:

1. A method for creating an interactive messenger, said method comprising the steps of:
a) creating a computer-controlled agent that engages in an interaction with a recipient via a communication channel;
b) enabling said agent to employ content in said interaction with said recipient, wherein at least some of said content is provided by a sender; and
c) providing a start mechanism for said interaction, wherein said start mechanism is sent to said recipient over said communication channel.

2. The method of claim 1, wherein said interaction comprises delivery of dialogue.

3. The method of claim 2, wherein said dialogue includes messenger dialogue delivered by said agent.

4. The method of claim 3, wherein said dialogue further comprises recipient dialogue delivered by said recipient.

5. The method of claim 4, wherein said messenger dialogue is determined in part by said recipient dialogue.

6. The method of claim 4, wherein said interaction includes an interaction component initiated by an initiating dialogue and continued by a responding dialogue.

7. The method of claim 1, wherein said interaction comprises an action selected from the group consisting of performing a gesture, operating a browser, operating a search engine, operating an application, reading from a database, and writing to a database.

8. The method of claim 1, wherein said interaction is designed to achieve a particular objective.

9. The method of claim 1, wherein said sender and said recipient have a relationship selected from the group consisting of employer-employee, enterprise-customer, teacher-student, friend-friend, professional-client, representative-constituent, and partner-partner.

10. The method of claim 1, wherein said agent further employs content representing a persona.

11. The method of claim 10, wherein said persona represents a known character.

12. The method of claim 10, wherein said persona represents a real person.

13. The method of claim 1, wherein said agent employs content representing a mood.

14. The method of claim 13, wherein said mood is dependent upon the performance of an action.

15. The method of claim 13, wherein said mood influences an action performed by said agent.

16. The method of claim 1, wherein said agent employs content representing an item from the group consisting of a visual appearance, an audible voice, and a chat topic.

17. The method of claim 1, wherein said communication channel is selected from the group consisting of email, telephone, personal digital assistant, and wireless device.

18. The method of claim 1, wherein said start mechanism requires a permission signal from said recipient.

19. The method of claim 1, further comprising generating a report.

20. The method of claim 19, wherein said report comprises information about the provision of said start mechanism to said recipient.

21. The method of claim 19, wherein said report comprises information about a start of said interaction with said recipient.

22. The method of claim 19, wherein said report comprises information about an action performed during said interaction.

23. The method of claim 19, wherein said report comprises a summary statistic of said interaction.

24. The method of claim 19, further comprising delivering said report to said sender.

25. The method of claim 24, wherein said delivery is via email.

26. The method of claim 24, wherein said delivery is via writing to a database.

27. The method of claim 1, wherein said content comprises a plurality of instructions to said agent.

28. The method of claim 27, wherein at least one of said instructions refers to an action of said agent.

29. The method of claim 28, wherein said at least one instruction includes a condition under which said agent should perform said action.

30. The method of claim 29, wherein said condition refers to an action of said recipient.

31. The method of claim 29, wherein said condition refers to a mood of said agent.

32. The method of claim 27, wherein at least one of said instructions provides an address of said recipient, wherein said start mechanism is sent to said address.

33. The method of claim 27, wherein at least one of said instructions provides an address of said sender, wherein a report of said interaction is sent to said address.

34. The method of claim 27, wherein at least one of said instructions provides a database in which a report of said interaction is written.

35. The method of claim 1, wherein said sender provides said content by filling in slots in a form.

36. The method of claim 35, wherein said content is automatically incorporated into said agent.

37. The method of claim 35, wherein said content is manually incorporated into said agent.

38. The method of claim 1, wherein said content is in a database.

39. The method of claim 38, wherein said content is retrieved by said agent from said database during said interaction.

40. The method of claim 38, wherein said database contains additional content for each of a plurality of additional recipients.

41. The method of claim 40, further comprising providing said start mechanism to said plurality of additional recipients in said database, wherein said agent employs said additional content for each of said additional recipients as specified in said database.

42. The method of claim 1, further comprising providing said start mechanism to a new recipient selected by said recipient.

43. The method of claim 42, wherein said recipient provides new content that said agent employs in a new interaction with said new recipient.

44. The method of claim 1, wherein said content depends on an identity of said recipient.
